(19) United States
(12) Patent Application Publication
(10) Pub. No.: US 2007/0006730 A1
(43) Pub. Date: Jan. 11, 2007

(54) Cleaning composition for treating an acid gas and method for making the same

(75) Inventors: Jung-Nan Hsu, Taichung City (TW); Shou-Nan Li, Nantou County (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 11/476,647

(22) Filed: Jun. 29, 2006

(30) Foreign Application Priority Data
Jul. 6, 2005 (TW) 94122841

(51) Int. Cl. B01D 53/14

(52) U.S. Cl. 95/235

(57) ABSTRACT

A cleaning composition for treating acid gas. The cleaning composition comprises an iron-containing oxide, and an oxide comprising at least aluminum, silicon, or titanium with a mesoporous structure. A method for treating an acid gas utilizing the cleaning composition comprising contacting an acid gas with the cleaning composition for lowering the concentration of the acid gas is also disclosed.

### BACKGROUND OF THE INVENTION

1. Field of the Invention

The present invention relates to a cleaning composition, and in particular to a cleaning composition for treating an acid gas.

2. Description of the Related Art

Semiconductor manufacture is a highly delicate industry. Subtle changes in environmental or operating conditions can affect product quality, thus, production equipments in semiconductor and LCD manufacturing facilities comprising clean rooms, operated under strict conditions, which mainly comprise oxidation ovens, diffusion equipment, cleaning containers, developing agent, ion implantation machines, and metal sputter deposition equipment. During operation, these productive equipments generate pollutants that can be classified by the treatment property, for examples, air pollutants can be divided into acid and alkaline gases, organic gases, and specifically toxic gases. Generally speaking, many acid gases are utilized in a dry etching process. Acid gases not capable of being sufficiently utilized in the process are expelled as process tail gasses. If the dangerous process tail gases near the process machine can not be removed, the load of the exhaust main-duct and sub-duct increases and threatens factory safety. Currently, methods for treating acid gases near the machine comprise wet cleaning and dry cleaning. Typically, the most cost effective method is wet cleaning. The pipeline utilized to expel water is easily blocked and broken due to erosion, thus, leakage can occur in the switch portion of the pipeline due to erosion or construction. Additionally, because manufacturing systems are continuously operated, water and power are consumed even if production is low. The dry adsorptive method is the most convenient method for maintaining operation. The method contacts untreated tail gases with adsorptive tanks containing cleaning compositions, and the compound formed by acid gases reacting with active radicals on the surface of the cleaning agents is then removed from the tanks. The adsorptive tanks are removed while switching valve, if the cleaning agents are saturated. The method not only provides convenience in use but also avoids unnecessary operational consumption during~ low production periods, as the dry adsorptive method does not require water and power. Accordingly, more vendors are utilizing the dry adsorptive method for treating dangerous gases. Nevertheless, operating costs are high because the adsorptive agents must frequently be replaced due to high utilization rate of acid gases. If low cost active carbon serves as the adsorptive material, is rather than more expensive materials, the adsorption is reduced and flammability is increased due to potential reaction of high concentration fluorine. Accordingly, the development of a novel adsorptive agent is desirable.

Various wet cleaning and dry cleaning methods for treating acid gas have been developed, related patents are listed in the following. JP-61-204022 and JP-62-125827 disclose a wet cleaning method comprising contacting sodium hydroxide alkaline solution with gas to adsorb and treat an acid gas. This method offers the advantage of low cost but must be periodically monitored for blockage and breakage due to erosion. Accordingly, water and power are consumed even when process usage is low. Various cleaning agents for use in dry cleaning method have been developed. The adsorptive tank for adsorbing acid gas is filled with the cleaning agents when tail gas flows. JP-60-68051 discloses a method for treating an acid gas by active carbons containing a compound with Zinc or alkaline. Although the method is inexpensive, the adsorptive capacity is low and is highly flammable. U.S. Pat. No. 5,094,825 discloses a cleaning agent mainly comprising ferric oxide for treating ClF₃, which utilizes commercial products and provides a simple manufacturing method. The adsorptive capacity, however, is too low. U.S. Pat. No. 5,670,445 (TW265270) also discloses a cleaning agent mainly consisting of ferrous iron oxide and strontium hydroxide for cleaning an acid gas and provides a simple manufacturing way. The manufacture of strontium hydroxide is, however, expensive, and the adsorptive capacity is inadequate. U.S. Pat. No. 5,756,060 (TW370470) discloses a cleaning agent primarily consisting of copper oxide and manganese oxide for treating an acid gas with halide. It is, however, expensive, and the adsorptive capacity is too low.

Accordingly, based on market requirements, a safe cleaning composition with high adsorptive capacity and low manufacturing cost is desirable.

### BRIEF SUMMARY OF THE INVENTION

The invention provides a cleaning composition capable of treating an acid gas generated during the manufacturing process and a method for treating an acid gas utilizing the cleaning composition. A detailed description is given in the following embodiments with reference to the accompanying drawings.

An exemplary embodiment of a cleaning composition for treating an acid gas comprises: an iron-containing oxide, and an oxide comprising at least aluminum, silicon, or titanium with a mesoporous structure.

An exemplary embodiment of method of a cleaning method for treating an acid gas comprises, contacting an untreated acid gas to a cleaning composition to lower the concentration of the acid gas. The utilized cleaning composition comprises an iron-containing oxide and an oxide containing at least aluminum, silicon, or titanium with a mesoporous structure.

### DETAILED DESCRIPTION OF THE INVENTION

The invention, which provides a cleaning composition for treating an acid gas and a method for making the same, will be described in greater detail by referring to the drawings that accompany the invention. It is noted that in the accompanying drawings, like and/or corresponding elements are referred to by like reference numerals. The following description discloses the best-contemplated mode of carrying out the invention. This description is made for the purpose of illustrating the general principles of the invention and should not be taken in a limiting sense. The scope of the invention is best determined by reference to the appended claims.

A cleaning composition for treating an acid gas comprising at least one active component and at least a structure promoter/carrier component is provided. The active component typically has a molecular weight percentage of 30% to 90%, and the other portions are the structure promoter/carrier component. Typically, the active component selects an active component with high specific surface, for example, an iron-containing oxide with a BET specific surface of 60 m²/g and the utilized carrier component contains at least aluminum, silicon, or titanium with a mesoporous structure.

The cleaning composition typically has a BET specific surface of more than 60 m²/g; preferably, the cleaning composition has a BET specific surface ranging from 130 m²/g to 190 m²/g.

The active component and structure promoter of the cleaning composition have a predetermined ratio within a certain range. When the amount of the active component is too low, the competent adsorptive capacity can not be reached. In addition, when the amount of the structure promoter is too low, the iron-containing oxide aggregates into a larger particle, and the water-storage capacity caused by the porous structure will decrease. Thus, the iron-containing oxide can not be utilized, and its adhesive capacity is simultaneously decreased.

In one embodiment, the cleaning composition comprises an active component with a molecular weight percentage of from 30% to 90% and an oxide containing aluminum, silicon, or titanium with a mesoporous structure. Preferably, the cleaning composition has a mix ratio of active component and aluminum oxide, wherein the ratio of Fe:Al ranges from 1:1 to 2:1. More preferably, the active component of the cleaning composition comprises a iron oxide including Fe₂O₃, Fe(OH)₃, FeOOH, FeO, and Fe₃O₄. Additionally, the oxide comprising at least aluminum, silicon, or titanium with a mesoporous structure comprises an aluminum oxide with a mesoporous structure, wherein the aluminum oxide with the mesoporous structure comprises γ-Al₂O₃.

In general, the treated acid gas comprises a gas including a halide, preferably, the gas including halide can be HCl, BCl₃, Cl₂, HF, HBr, or SiF₄.

An exemplary embodiment of a method for preparing the cleaning composition of the invention comprises: dissolving a precursor containing iron in adequate volume in the deionic water. γ-Al₂O₃. with a mesoporous structure is then added until achieving the Fe/Al ratio of 1:1. Thereafter, pH value of the solution is adjusted by adding sodium hydroxide, thus, the iron-containing precipitate is formed. After drying and calcining procedures, a cleaning composition with a BET (Brunauer, Emmett and Teller) specific surface greater than 60 m²/g is formed by separation between solid and liquid forms in the solution. Thereafter, a molding agent or/and promoter are added and sufficiently mixed. An adhesive agent is subsequently added to form the cleaning composition.

In some embodiments, the molding agent or/and promoter typically comprises a calcium-containing oxide or a magnesium-containing oxide, preferably, the molding agent further comprises calcium oxide, magnesium oxide, calcium hydroxide, and magnesium hydroxide. Note that the molding agent generally has a molecular weight percentage from 5% to 30%; preferably, the molding agent has a molecular weight percentage from 15% to 20%.

Typically, the adhesive used for the cleaning composition comprises sodium silicate, sodium formate, methyl cellulose, or polyvinyl alcohol. Note that the adhesive typically has a molecular weight percentage of from 1% to 10%; preferably, the adhesive has a molecular weight percentage from 1% to 2%.

The oxide containing at least aluminum, silicon, or titanium with a mesoporous structure is prepared by sol-gel or purchase of a commercial products.

A method for treating an acid gas is also disclosed. An exemplary embodiment of the method comprises contacting an untreated acid gas to a cleaning composition for lowering the concentration of the acid gas. The cleaning composition comprises an iron-containing oxide and an oxide containing at least aluminum, silicon, or titanium with a mesoporous structure. Typically, the acid gas comprises a gas with halide, preferably, the gas with halide comprises HCl, BCl₃, Cl₂, HF, HBr, or SiF₄.

The invention will be described in greater detail by referring to the following examples. The following description discloses the best-contemplated mode of carrying out the invention. This description is made for the purpose of illustrating the general principles of the invention and should not be taken in a limiting sense.

### COMPARATIVE EXAMPLE 1

Ferric oxide (Fe₂O₃) powder is processed by pressing and molding followed by crushing and sieving out the particles of 0.425˜0.85 mm to serve as a cleaning composition. The category of the iron-containing oxide can be in any shape or in any form for subsequent processes without any further purifying treatment.

Adhesive Capacity Test for Cleaning Composition

Hydrogen chloride (HCl) served as a test gas in both examples and comparative examples in the disclosure.

30 ml formed cleaning composition was filled into a stainless steel test chamber with an inside diameter of 27 mm. The filled length was approximately 52 mm. After the test chamber and the system pipe line were purged with nitrogen for 30 mins, 30000 ppm hydrogen chloride gas diluted by nitrogen with linear velocity of 0.6 cm/sec was introduced The amount of hydrogen chloride gas introduced is the adhesive capacity of cleaning composition when the concentration of hydrogen chloride gas near the outlet of the test chamber is over the limited value 300 ppm. The flow of gas was controlled by mass flow controller, while the gas concentration near the outlet of the test chamber was continuously monitored by FTIR. Thus, the breakthrough occurs when the concentration of hydrogen chloride gas is raised to 300 pm, which is calculated into adhesive capacity.

### Example 1

Ferric nitrate (Fe(NO₃)₃.9H₂O) was dissolved in the deionic water with adequate volume. γ-Al₂O₃ with a mesoporous structure was added to the ratio of Fe/Al 1:1. Thereafter, PH value of the solution was adjusted by sodium hydroxide, thus, the iron-containing precipitate was formed. After drying and calcining, a cleaning composition with BET specific surface 150 m²/g was formed. 5% magnesium oxide was subsequently added as a molding agent/promoting agent with sufficient mixing, and sodium silicate was then added as adhesive followed by pressing and molding. Thereafter, the powder was heated for 2 hours under 120° C., and the pressing and molding process was executed followed by crushing and sieving out the particles of 0.425˜0.85 mm to serve as a cleaning composition. The formed cleaning composition had a specific surface 150 m²/g as determined by the BET analysis method. The adhesive capacity test for the cleaning composition was executed under the same test conditions as comparative example 1. The test result is shown in Table 1.

### Example 2

A cleaning composition was prepared by repeating the steps recited above, and ferric nitrate (Fe(NO₃)₃.9H₂O) was sufficiently mixed with γ-Al₂O₃ referring to the ratio of Fe/Al 2:1. The formed cleaning composition had a specific surface 188 m²/g as determined by the BET analysis method. The adhesive capacity test for the cleaning composition was executed under the same test conditions as comparative example 1. The test result is shown in Table 1.

TABLE 1

| | | | Adhesive |
|---|---|---|---|
| Experiment | Primary | | Capacity |
| No | Composition | BET, m²/g | (kg HCl/kg ads) |
| Comparative | Fe2O3 | 3.4 | 0.005 |
| Example 1 | | | |
| Example 1 | Fe/Al = 1:1 | 150 | 0.46 |
| Example 2 | Fe/Al = 2:1 | 188 | 0.66 |

Referring to the result shown in Table 1, the cleaning composition with the active component of iron-containing oxide, in which γ-Al₂O₃ is added, formed in examples 1 and 2 has higher adhesive capacity than a conventional cleaning composition containing only ferric oxide. Due to a higher ratio of Fe/Al, the cleaning composition in the example 2 has a better adhesive capacity than that in example 1.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A cleaning composition for treating an acid gas, comprising:
an iron-containing oxide; and
an oxide comprising at least aluminum, silicon, or titanium with a mesoporous structure.

2. The cleaning composition as claimed in claim 1, wherein the iron-containing oxide has a BET (Brunauer, Emmett and Teller) specific surface greater than 60 m²/g.

3. The cleaning composition as claimed in claim 1, wherein the cleaning composition has a BET specific surface greater than 60 m²/g.

4. The cleaning composition as claimed in claim 1, wherein the cleaning composition has a BET specific surface ranging from 130 m2/g to 190 m²/g.

5. The cleaning composition as claimed in claim 1, wherein the oxide comprising at least aluminum, silicon, or titanium with a mesoporous structure comprises an aluminum oxide with a mesoporous structure, wherein the aluminum oxide with the mesoporous structure comprises γ-Al₂O₃.

6. The cleaning composition as claimed in claim 5, wherein the iron-containing oxide and the aluminum oxide with the mesoporous structure have a mixture ratio, wherein the ratio of Fe:Al ranges from 1:1 to 2:1.

7. The cleaning composition as claimed in claim 1, wherein the iron-containing oxide has a molecular weight percentage from 30% to 90%.

8. The cleaning composition as claimed in claim 1, wherein the iron-containing oxide comprises Fe₂O₃, Fe(OH)₃, FeOOH, FeO, or Fe₃O₄.

9. The cleaning composition as claimed in claim 1, wherein the acid gas comprises a gas with halide.

10. The cleaning composition as claimed in claim 8, wherein the gas with halide comprises HCl, BCl₃, Cl₂, HF, HBr, or SiF₄.

11. The cleaning composition as claimed in claim 1, further comprising a molding agent, wherein the molding agent comprises a calcium-containing oxide or a magnesium-containing oxide.

12. The cleaning composition as claimed in claim 1, further comprising a molding agent, wherein the molding agent comprises calcium oxide, magnesium oxide, calcium hydroxide, and magnesium hydroxide.

13. The cleaning composition as claimed in claim 10, wherein the molding agent has a molecular weight percentage from 5% to 30%.

14. The cleaning composition as claimed in claim 12, wherein the molding agent has a molecular weight percentage from 15% to 20%.

15. The cleaning composition as claimed in claim 1, further comprising an adhesive, wherein the adhesive comprises sodium silicate, sodium formate, methyl cellulose, or polyvinyl alcohol.

16. The cleaning composition as claimed in claim 14, wherein the adhesive has a molecular weight percentage from 1% to 10%.

17. The cleaning composition as claimed in claim 15, wherein the adhesive has a molecular weight percentage from 1% to 2%.

18. A method for treating an acid gas, comprising:
contacting an acid gas with a cleaning composition for lowering the concentration of the acid gas;
wherein the cleaning composition comprises an iron-containing oxide and an oxide containing at least aluminum, silicon, or titanium with a mesoporous structure.

19. The method as claimed in claim 18, wherein the iron-containing oxide has a BET (Brunauer, Emmett and Teller) specific surface greater than 60 m²/g.

20. The method as claimed in claim 18, wherein the cleaning composition has a BET specific surface greater than 60 m²/g.

21. The method as claimed in claim 18, wherein the cleaning composition has a BET specific surface ranging from 130 m²/g to 190 m²/g.

22. The method as claimed in claim 18, wherein the oxide comprising at least one of aluminum, silicon, or titanium with a mesoporous structure comprises an aluminum oxide with a mesoporous structure, wherein the aluminum oxide with the mesoporous structure comprises γ-Al₂O₃.

23. The method as claimed in claim 22, wherein the iron-containing oxide and the aluminum oxide with mesoporous structures comprise a mixture ratio, wherein the ratio of Fe:Al ranges from 1:1 to 2:1.

24. The method as claimed in claim 18, wherein the iron-containing oxide has a molecular weight percentage from 30% to 90%.

25. The method as claimed in claim 18, wherein the iron-containing oxide comprises Fe₂O₃, Fe(OH)₃, FeOOH, FeO, or Fe₃O₄.

26. The method as claimed in claim 18, wherein the acid gas comprises a gas with halide.

27. The method as claimed in claim 26, wherein the gas with halide comprises HCl, BCl₃, Cl₂, HF, HBr, or SiF₄.

28. The method as claimed in claim 18, further comprising a molding agent, wherein the molding agent comprises a calcium-containing oxide or a magnesium-containing oxide.

29. The method as claimed in claim 18, further comprising a molding agent, wherein the molding agent comprises calcium oxide, magnesium oxide, calcium hydroxide, or magnesium hydroxide.

30. The method as claimed in claim 28, wherein the molding agent has a molecular weight percentage from 5% to 30%.

31. The method as claimed in claim 28, wherein the molding agent has a molecular weight percentage from 15% to 20%.

32. The method as claimed in claim 18, further comprising an adhesive, wherein the adhesive comprises sodium silicate, sodium formate, methyl cellulose, or polyvinyl alcohol.

33. The method as claimed in claim 32, wherein the adhesive has a molecular weight percentage from 1% to 10%.

34. The method as claimed in claim 32, wherein the adhesive has a molecular weight percentage from 1% to 2%.
